(19) United States
(12) Patent Application Publication
(10) Pub. No.: US 2009/0152039 A1
(43) Pub. Date: Jun. 18, 2009

(54) ATTACHABLE POWER DEVICE FOR BIKE

(76) Inventor: Jae Ho HONG, BUCHEON-SI (KR)

Correspondence Address: IPLA P.A., 3580 WILSHIRE BLVD., 17TH FLOOR, LOS ANGELES, CA, 90010, US

(21) Appl. No.: 12/338,842

(22) Filed: Dec. 18, 2008

(30) Foreign Application Priority Data
Dec. 18, 2007 (KR) 10-2007-0133509

(51) Int. Cl. B62M 7/00

(52) U.S. Cl. 180/231

(57) ABSTRACT

The attachable power device for a bike comprises a base plate installed in an upper side of the rear wheel; a motor and a decelerator which are installed in one side of an upper side of the base plate; an inner casing which includes a power supply unit for supplying power to the motor and is detachably attached to the other side of an upper side of the base plate; an outer casing which is configured to accommodate the inner casing, the motor and the decelerator and is engaged to an upper side of the base plate; a chain sprocket which is installed in a left side of the hub of the rear wheel; a connection member which connects the chain sprocket and the driving sprocket of the decelerator; and a control unit which is installed in the handle and controls a driving of the motor.

### CROSS REFERENCE

This application claims foreign priority under Paris Convention and 35 U.S.C. §119 to Korean Patent Application No. 10-2007-0133509, filed Dec. 18, 2008 with the Korean Intellectual Property Office.

### BACKGROUND OF THE INVENTION

The present invention relates to an attachable power device for a bike, and in particular to an attachable power device for a bike which can be easily attached to a common bike, and can be motored when running a long distance along with a running operation by pedals.

Generally, a bike is so configured that a user can rotate a front sprocket using pedals, and a rotational force generated is transferred to a rear gear part through a chain for thereby rotating a rear wheel.

The conventional common bike has not problems when running on a flat ground, but when running a long distance or a slope, a lot of force is needed.

So as to overcome the above problems, an electric bike is developed, in which a driving force is generated by an electric motor along with a pedaling work.

The conventional electric bike includes a frame and other elements, which are exclusively manufactured in a factory.

So, a manufacturer needs to manufacture a frame and other elements separately from a conventional bike, so manufacturing a conventional electric bike costs a lot. Since the price is expensive, there are problems to become popular.

In case that a conventional electric bike adapts a front wheel-driven type and a rear wheel-driven method, when an air pressure of a wheel is lowered, a tire might be over worn out.

In addition, in case of a direct driving method that an electric motor is attached to a front wheel shaft or a rear wheel shaft, it is needed to separately manufacture wheels, and a special motor is needed, which costs a lot.

When a motor and a battery are attached to a conventional electric bike, it is needed to modify the structure of a bike, which cost a lot as well.

### SUMMARY OF THE INVENTION

Accordingly, it is an object of the present invention to provide an attachable power device for a bike which overcomes the problems encountered in the conventional art.

It is another object of the present invention to provide an attachable power device for a bike which can be manufactured and used at a lower cost by detachably attaching the device of the present invention to a conventional bike for a motored driving along with a pedaling method.

To achieve the above objects, there is provided an attachable power device for a bike characterized as being installed in a bike in which a front wheel 200 and a rear wheel 300 are installed in the front and rear sides of a reverse triangle frame 100, and a front sprocket 600 connected with pedals 500 is installed in an intermediate lower portion of the same, and a multi-stage gear sprocket 900 is installed in a right side of a hub 800 of the rear wheel 300, and a chain 700 connects the front sprocket 600 and the multi-stage gear sprocket 900. The attachable power device for a bike comprises a base plate 2 installed in an upper side of the rear wheel 300; a motor 3 and a decelerator 4 which are installed in one side of an upper side of the base plate 2; an inner casing 5 which includes a power supply unit for supplying power to the motor 3 and is detachably attached to the other side of an upper side of the base plate 2; an outer casing 6 which is configured to accommodate the inner casing 5, the motor 3 and the decelerator 4 and is engaged to an upper side of the base plate 2; a chain sprocket 7 which is installed in a left side of the hub 800 of the rear wheel 300; a connection member 8 which connects the chain sprocket 7 and the driving sprocket 44 of the decelerator 4; and a control unit which is installed in the handle 400 and controls a driving of the motor 3.

In the present invention, since it is possible to change a conventional bike to an electric bike by attaching only a small number of parts without changing a lot of the construction of a conventional bike, which can save a lot of cost.

The present invention has the same functions as the functions of the conventional electric bike such as forward, backward movements, transformation, idle rotation or the like, so there are not functional problems as compared to the conventional electric bike.

Since expensive battery, control unit, charging unit or the like can be detachably attached, a robbery can be prevented, and a lighter weight of electric bike can be possible, and it is easy to move with hands and to store the same.

A battery charging is very easy since only a detachable inner casing can be moved.

It is possible to more increase a fun and exercise effect of pedaling along with a convenience of a forward movement with the helps of a normal and reverse pedaling work and a real time pedaling method which are disclosed in the Korean patents numbers 0479870, 0479871, 0479872 and 0479873 which are filed by the same applicant as the present invention.

Since the present invention can be well adapted to a conventional secondhand bike and a finished bike, it is possible to easily change to an electric bike.

### BRIEF DESCRIPTION OF THE DRAWINGS

FIG. 1 is a front view illustrating a state that a power device is engaged to a bike according to the present invention.

FIG. 2 is an enlarged view illustrating a part of a rear wheel of FIG. 1.

FIG. 3 is a rear view illustrating a state that a power device is installed in a bike according to the present invention.

FIG. 4 is a view illustrating a control unit according to the present invention.

### DETAILED DESCRIPTION THE INVENTION

The present invention relates to an apparatus which can be adapted to a conventional common bike. In the conventional bike, a front wheel 200 and a rear wheel 300 are installed in the front and rear sides of a reverse triangle frame 100. A front sprocket 600 connected with pedals 500 is installed in an intermediate lower portion of the same. A multi-stage gear sprocket 900 is installed in a right side of a hub 800 of the rear wheel 300. A chain 700 connects the front sprocket 600 and the multi-stage gear sprocket 900.

The construction and embodiments of the present invention will be described with reference to the accompanying drawings.

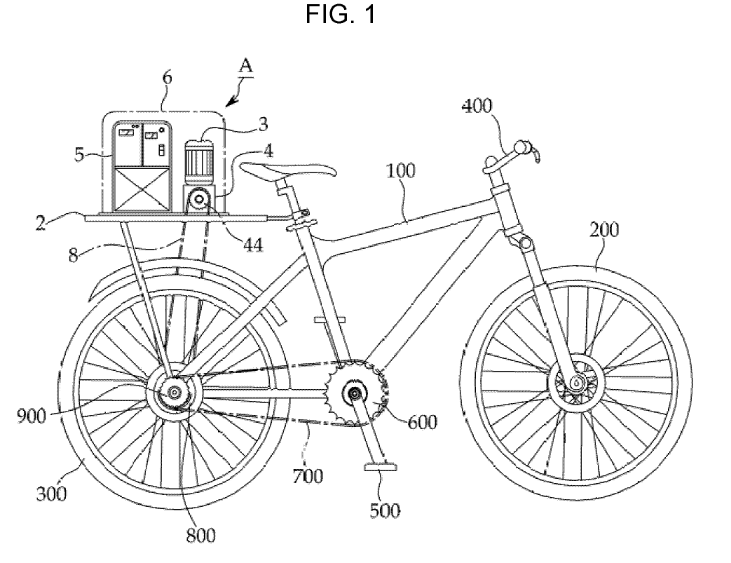

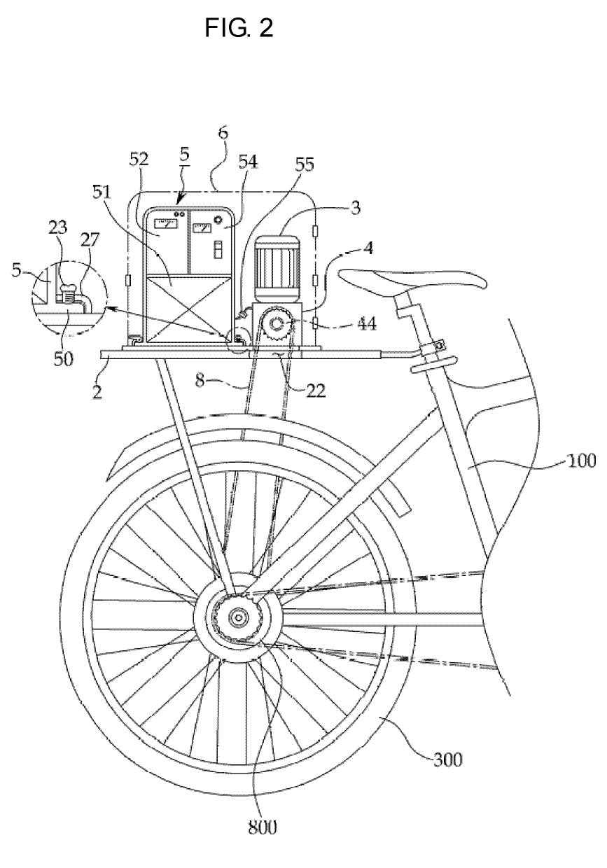

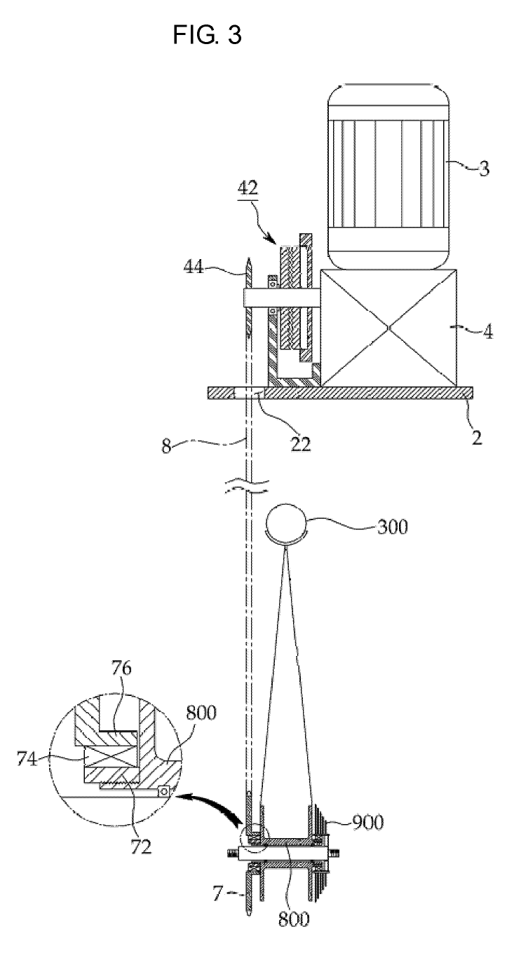

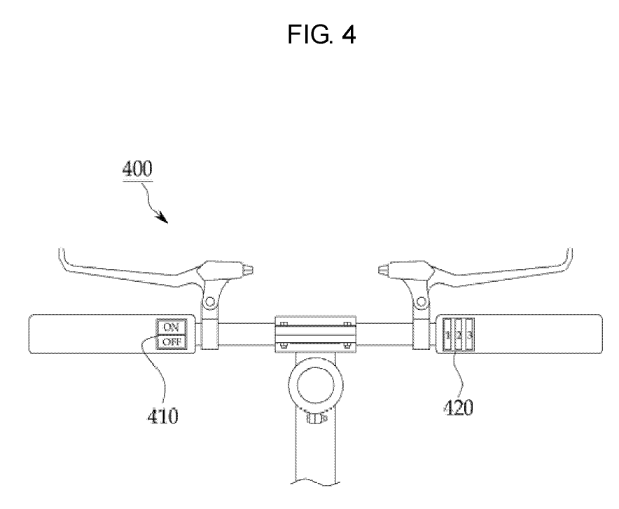

FIG. 1 is a front view illustrating a state that a power device is engaged to a bike according to the present invention. FIG. 2 is an enlarged view illustrating a part of a rear wheel of FIG. 1. FIG. 3 is a rear view illustrating a state that a power device is installed in a bike according to the present invention. FIG. 4 is a view illustrating a control unit according to the present invention.

As shown in FIGS. 1 and 2, a connection part of a driving sprocket 44 and a connection member 8 is shown with an imaginary line for the simplified descriptions.

As shown in FIGS. 1 through 3, the attachable power device A for a bike comprises a base plate 2 installed in an upper side of the rear wheel 300; a motor 3 and a decelerator 4 which are installed in one side of an upper side of the base plate 2; an inner casing 5 which includes a power supply unit for supplying power to the motor 3 and is detachably attached to the other side of an upper side of the base plate 2; an outer casing 6 which is configured to accommodate the inner casing 5, the motor 3 and the decelerator 4 and is engaged to an upper side of the base plate 2; a chain sprocket 7 which is installed in a left side of the hub 800 of the rear wheel 300; a connection member 8 which connects the chain sprocket 7 and the driving sprocket 44 of the decelerator 4; and a control unit which is installed in the handle 400 and controls a driving of the motor 3.

In more details, the base plate 2 is a rectangular plate material like a conventional baggage rest and includes a guide grove 27 on its upper side for detachably attaching an inner casing 5, and a chain groove 22 with a connection member 8 passing through the chain groove and is fixed as its front end is engaged to a frame of a lower side of a saddle, and a vertical support member of a lower side is engaged to a shaft of a hub 800.

The guide groove 27 is formed in a rail shape having a certain length, with a fixing member being installed in its upper side for fixing the inner casing 5. Here, the fixing member might be a tightening bolt 23 or a tightening lever.

An electronic clutch 42 is installed in one side of the base plate 2 and is connected with the decelerator 4.

Here, the motor 3 and the decelerator 4 are configured to generate a driving force. The motor 3 is preferably a BLDC motor of 24V.

The decelerator 4 is formed of a plurality of gears for slowing down the rotation speed of the motor 3 while increasing a torque, which becomes a running driving force. The above construction is a known art, so the detailed descriptions are omitted.

An output shaft of the decelerator 4 is connected with the electronic clutch 42, and a driving sprocket 44 connected with the connection member 8 is axially connected with the electronic clutch 42. So, the driving force transfer to the hub 800 is connected or disconnected depending on the on/off operations of the electronic clutch 42.

When the electronic clutch 42 is in the on state, the driving force from the decelerator 4 allows the connection member 8 to rotate, and the hub 800 rotates. On the contrary, when the electronic clutch 42 is in the off state, the driving force transfer to the hub 800 is disconnected.

The inner casing 5 is formed in a rectangular box shape and accommodates a power supply unit configured to supply power to the motor 3. A shoulder 50 inserted into the guide groove 27 is formed in a lower outer surface of the same. The inner casing can be fixed by tightening a tightening bolt 23, which is a fixing member, after the shoulder 50 is inserted into the guide groove 27 of the base plate 2.

The power supply unit comprises a battery 51 which is connected with the motor 3 and the power connector 55 for supplying power, a charging unit 52 electrically connected with the battery 51, and a control unit 54 for controlling the operations of the charging unit 52.

With the above constructions, the battery 51 can be charged by applying power to the charging unit 52 after the inner casing 5 is separated.

A chain sprocket 7 connected with the driving sprocket 44 of the decelerator 4 through the connection member 8 is axially engaged to a left side of the hub 800.

The chain sprocket 7 is installed in an outer side of the inner wheel 72 engaged to the hub 800, with one direction clutch 74 being installed between the inner wheel 72 and the chain sprocket 7. The chain sprocket 7 rotates when the rear wheel 300 runs forwards, and when it runs backwards, the chain sprocket 7 rotates idle.

In the above descriptions, it is assumed that the connection member 8 is a chain. However, it is not limited to the same. The connection member 8 might be formed of a belt such as a timing belt.

The control unit includes an on/off switch 410 installed in a left side of the handle 400, and a speed controller 420 installed in a right side of the handle.

The on/off switch 410 controls an operation that power is supplied to the motor 3. The speed controller 420 increases or decreases the rotation speed of the motor 3 by steps for thereby controlling a running speed.

The operations of the present invention will be described.

First, in a state that the on/off switch 410 of the control unit is in an off state, a user pedals in a conventional method using the pedals, the rear wheel 300 is rotated with a rotational force of the chain 700.

When the chain 700 engaged with the front sprocket 600 rotates, the multi-stage sprocket 900 rotates, and the hub 800 rotates. As the rear wheel 300 rotates, the inner wheel 72 engaged to a left side of the hub 800 rotates. At this time, the rotational force transferred to the inner wheel 72 is not transferred to the outer wheel 76 with the help of one direction clutch 74, namely, rotates ideal, so the chain sprocket 7 attached to the outer wheel 76 does not rotate.

The above operation can be easily known by understanding an operation that a bike runs down along a down slope by the weights of the bike and user unless a user pedals. At this time, the rear wheel 300 of the bike rotates, and even when the inner wheel 72 of one direction clutch 74 rotates, the chain sprocket 7 attached to the outer wheel 76 does not rotate.

Second, in case that a bike runs up along an up slope by pedaling, the on/off switch 410 of the control unit is turned on, and the motor 3 is driven, and the decelerator 4 rotates.

Since the electronic clutch 42 is in an on state, the rotational force of the decelerator 4 allows the driving sprocket 44 to operate through the electronic clutch 42.

The rotational force of the driving sprocket 44 is transferred to the connection member 8, so the outer wheel 76 of the hub 800 rotates.

So, the rotational force of the outer wheel 76 rotates the inner wheel 72 being integral with the hub 800 of the other side of the bike with the help of one direction clutch 74 for thereby rotating the hub 800, so the rear wheel 300 is driven in the forward direction. Therefore, the bike can move forward with the help of the driving of the motor 3.

Here, it is possible to further increase the rotational force along with a manual pedaling work. The user can select a motored operation and a manual operation or a combined operation.

Third, when the user wants to move the bike backwards or wants to move backwards and then to change the direction, the rotational force generated as the rear wheel 300 rotates in a reverse direction like a conventional bike, is transferred to the inner wheel 72 of one direction clutch 74. At this time, the outer wheel 76 of one direction clutch 74 rotates in a reverse direction, so the chain sprocket 7 rotates in a reverse direction.

As the chain sprocket 7 of the hub 800 rotates in a reverse direction, the connection member 8 rotates in a reverse direction as well. At this time, since the electronic clutch 42 is in a turned off state, a reverse direction rotation is not transferred to the decelerator 4, and only an armature in the electronic clutch 42 rotates ideal in a reverse direction along with the connection member 8 and the chain sprocket 7.

The fixing member of the inner casing 5 is released, and the power collector 55 is released, and then the inner casing 5 is removed for charging the battery. So, it is very convenient to charge.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. An attachable power device for a bike characterized as being installed in a bike in which a front wheel and a rear wheel are installed in the front and rear sides of a reverse triangle frame, and a front sprocket connected with pedals is installed in an intermediate lower portion of the same, and a multi-stage gear sprocket is installed in a right side of a hub of the rear wheel, and a chain connects the front sprocket and the multi-stage gear sprocket, comprising:
a base plate installed in an upper side of the rear wheel;
a motor and a decelerator which are installed in one side of an upper side of the base plate;
an inner casing which includes a power supply unit for supplying power to the motor and is detachably attached to the other side of an upper side of the base plate;
an outer casing which is configured to accommodate the inner casing, the motor and the decelerator and is engaged to an upper side of the base plate;
a chain sprocket which is installed in a left side of the hub of the rear wheel;
a connection member which connects the chain sprocket and the driving sprocket of the decelerator; and
a control unit which is installed in the handle and controls a driving of the motor.

2. The device of claim 1, wherein an electronic clutch engaged to the decelerator is installed in the base plate, and a driving force transfer to the hub is on/off controlled by means of an on/off operation of the electronic clutch.

3. The device of claim 2, wherein said base plate includes a guide groove formed in an upper surface of the same for detachably attaching the inner casing, a chain groove with the connection member passing through the chain groove, and a fixing means formed in an upper side of the guide groove.

4. The device of claim 3, wherein said inner casing includes a shoulder formed in an outer surface of the lower side and inserted into the guide groove.

5. The device of claim 1, wherein said power supply unit includes a battery electrically connected with the motor, a charging unit electrically connected with the battery, and a control unit for controlling the operations of the charging unit.

6. The device of claim 1, wherein said chain sprocket is installed in an outer side of the inner wheel engaged to the hub, and one direction clutch is installed between the inner wheel and the chain sprocket.

7. The device of claim 1, wherein said control unit includes an on/off switch installed in the handle, and a speed adjusting unit.
